(19) United States
(12) Patent Application Publication
(10) Pub. No.: US 2010/0038907 A1
(43) Pub. Date: Feb. 18, 2010

(54) Power Generation

(75) Inventors: Sam R. Hunt, Abilene, TX (US); Bruce Stephen Zenone, Nellysford, VA (US)

Correspondence Address: FISH & RICHARDSON P.C., P.O BOX 1022, Minneapolis, MN, 55440-1022, US

(73) Assignee: EncoGen LLC, Abilene, TX (US)

(21) Appl. No.: 12/433,240

(22) Filed: Apr. 30, 2009

Related U.S. Application Data
(60) Provisional application No. 61/188,943, filed on Aug. 14, 2008.

(51) Int. Cl. H02P 9/02; F02C 9/26; F02C 9/56; H02K 7/18

(52) U.S. Cl. 290/7; 60/793; 60/39.25; 60/39.281; 290/52; 290/40 B; 290/43

(57) ABSTRACT

In one aspect, power generation is accomplished by capturing off-gas from a wellhead of an oil producing well, sensing a change in pressure from which a change in available off-gas can be determined, and adjusting a torque supplied by a prime mover to a generator responsive to the change in available off-gas to vary an amount of electricity generated by the generator.

### CROSS-REFERENCE RELATED APPLICATIONS

This application claims the benefit of the filing date of U.S. Provisional Application No. 61/188,943, which was filed on Aug. 14, 2008. The contents of U.S. Application No. 61/188,943 are incorporated by reference in their entirety as part of this application.

### TECHNICAL FIELD

This invention relates to energy production and conservation as well as enhancement of environmental quality and, in particular, the production of electrical energy from gas captured at a wellhead.

### BACKGROUND

Recent trends in global warming have focused the attention of many on the emission of greenhouse gases and energy conservation. Greenhouse gases include, for example, water vapor, carbon dioxide, ozone, nitrous oxide, methane, and chlorofluorocarbons (CFCs). Recent studies have shown that increases in greenhouse gas concentrations in the atmosphere resulting from human activity is very likely to have caused most of the increases in global average temperatures since the mid-20th century. Although the proper metric for comparing the effect of the various gases on the climate remains in debate, the metric recommended by the Intergovernmental Panel on Climate Change (IPCC) is global warming potential (GWP) using carbon dioxide as a reference point. In general, the global warming potential provides an indication of the impact the gas has on global warming over a period of time relative to that of carbon dioxide per unit weight. For example, the GWP of carbon is 1 for all time periods, and the GWP of methane is 25 for a 100 year period. Thus, 1 metric ton of methane is estimated to have an impact equivalent to 25 metric tons of carbon dioxide over a period of 100 years.

Sources of greenhouse gases include, for example, landfills, waste water processing plants, chemical plants, natural gas processing plants, natural gas wells, and oil wells. For example, a gaseous mixture of hydrocarbons commonly referred to as off-gas is released when crude oil is pumped from natural petroleum reservoirs. A primary component of off-gas is methane gas. The off-gas is usually vented or flared at or near the wellhead, contributing to atmospheric pollution without providing any beneficial use.

There exists a need for reducing or eliminating greenhouse gas emissions and for eliminating the waste of natural resources.

### SUMMARY

In one aspect, power generation is accomplished by capturing off-gas from a wellhead of an oil producing well, sensing a change in pressure from which a change in available off-gas can be determined, and adjusting a torque supplied by a prime mover to a generator responsive to the change in available off-gas to vary an amount of electricity generated by the generator.

The details of various embodiments of the invention are set forth in the accompanying drawings and the description below. Other features, objects, and advantages of the invention will be apparent from the description and drawings, and from the claims.

### DESCRIPTION OF DRAWINGS

FIG. 1 is a system diagram of a power generation system.

FIG. 2 illustrates an example of a power generation system including a governor.

FIG. 3 illustrates an example of a power generation system including an accumulator tank.

FIG. 4 is a system state diagram of a power generation system.

FIG. 5 is a system state diagram of a freerun mode.

FIG. 6A is a system state diagram of a load connection sequence.

FIG. 6B is a system state diagram of a load power sequence.

FIG. 7 is a system state diagram of a synchronization sequence.

FIG. 8 is a system state diagram of a bus connection sequence.

FIG. 9 is a system state diagram of a cogeneration mode.

FIGS. 10A-10C illustrate example PID algorithms.

FIG. 11 is a diagram of an automated power generation control system.

FIG. 12 is a diagram of an automated power generation control system with a fused generator.

FIG. 13 is a diagram of an automated power generation control system with a hybrid protection arrangement including a swap-over switch.

FIG. 14 is a diagram of an automated power generation control system with a gas turbine.

FIG. 15 is a diagram of a mobile power plant.

### DETAILED DESCRIPTION

The perceived value of capturing off-gas from oil producing wells has typically been very low due to the limited volumes and in some cases, the lack of infrastructure for collecting and distributing the gas. In many cases, the economics of off-gas collection weigh in favor of disposing of it by venting or flaring the gas at or near the wellhead rather than collecting and distributing the gas. Flaring causes pollution that not only affects the atmosphere, but may also cause health and nuisance issues for nearby residents. In some countries, the amount of gas flared in a single year could power cities within that country, and/or the entire country for a substantial period of time. In addition to the environmental impact, venting or flaring wellhead gas results in waste of a natural resource. Capturing the gas at the wellhead and using it to generate power not only reduces the greenhouse gas emissions related to oil and natural gas production, but also prevents the waste of a natural resource by converting it into something useful. In some cases, on-site generation may eliminate the need for and the cost of piping the gas to a central facility by converting it into power that can be used in the local region and/or transmitted over existing power lines. This may be particularly useful in regions where the installation of gas pipelines would be cost prohibitive or impossible due to physical constraints.

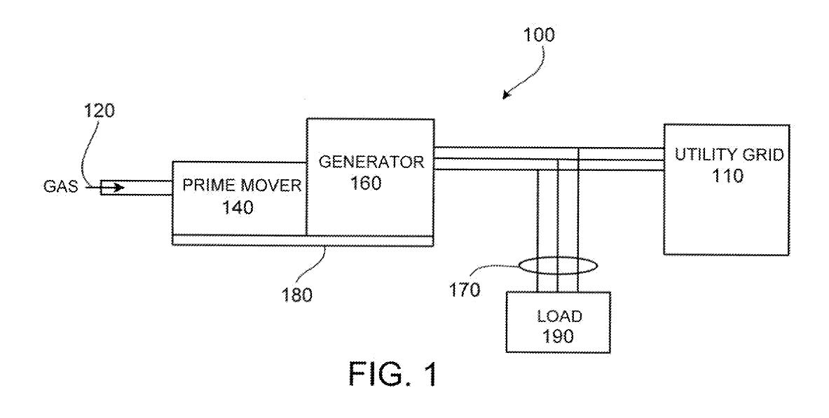

FIG. 1 is a system diagram of power generation system 100. Natural gas 120 is used to fuel engine 140 coupled with generator 160, commonly referred to as an engine-generator set, or gen-set, when assembled as a single piece of equipment 180. Although the prime mover in this example is a natural gas powered internal combustion engine 140, other prime movers may be used including, for example, gas turbines, water turbines, steam turbines, and/or diesel engines. In general, synchronous generators are preferred over induction generators due to their ability to generate both real and reactive power smoothly. Newer induction generators, for example, wind turbine generators, are now designed with selectable power factor settings to make reactive power generation possible. The selection of the prime mover may, in some cases, depend on the amount of gas flow available and the limits imposed by the utility grid operators. In addition to differences in costs, power output, and efficiency, different types of prime movers provide different advantages and disadvantages. For example, a gas turbine generator is less susceptible to damage resulting from brief instances of reverse power flow, i.e. such as when an insufficient amount of gas is available to maintain a positive torque on the generator.

The ability to generate real and reactive power may also provide for a reduction in transmission power losses, particularly when power generation system 100 is located near a load center, such as a densely populated city. In addition to reducing the amount of reactive power that the utility power plant must generate, distributed power generation also reduces the need for new high power transmission lines and the losses associated with the use of such lines, thereby reducing the carbon footprint of the utility power plant and the manufacturing plants that process the materials necessary for manufacturing transmission lines.

Gen-set 180 in the example of FIG. 1 operates in a free-running mode such that the flow rate of fuel 120 into gen-set 180 is allowed to vary resulting in a corresponding variation in power output from generator 160. The power generated may be used to power a local load 190 and/or supplied to a utility grid 110. For example, in a load-sharing mode, the gen-set power output is synchronized with utility grid 110 and supplied to a load via common power bus 170. As the demand from the load increases beyond the power output of generator 160, load 190 draws more power from utility grid 110. Similarly, as the demand from load 190 decreases below the power output of generator 160, the excess generated power is stored, and/or supplied to utility grid 110.

In some examples, excess power is stored using energy storage devices including, for example, flywheel, hydroelectric, and geothermal energy storage devices. Other energy storage devices include battery banks, superconducting magnetic energy storage, etc. Storing the excess power generated may be particularly useful in cases when demand for utility power and the corresponding utility rates are low. Thus, releasing the power during high demand periods benefits the users of the utility grid and may lead to a higher rate of return due to peak period utility rates. In addition, as induction generators such as windmill generators become more prevalent, the need for additional spinning reserve may increase in order to compensate for the fluctuations in power produced by induction generators.

A gen-set typically includes a governor that regulates the throttle on the engine to adjust the flow of fuel to the engine. As the flow increases, the speed of the motor increases creating a corresponding increase in torque supplied to the generator. This increase in torque results in an increase in the amount of power being generated. Generally, the amount of power generated is adjusted in response to a change in demand from a load. One reason for this is to avoid consuming more fuel than necessary to meet the demand from the local load. Bypassing this control mechanism and manually increasing the throttle to maximum, for example, to maximize the output from the generator, may allow for the generation and supply of excess power to the utility grid. However, such an implementation would depend on a constant flow of fuel, and thus, would fail to compensate for variability in the fuel supply. For example, if the amount of available fuel was to decrease below an amount necessary to keep a positive torque applied to the generator at full throttle, the generator would drop into motor mode and begin consuming real and reactive power from the utility grid. This is an undesirable result because it requires that the utility company anticipate the reactive load increase and implement countermeasures for dealing with this increase, for example, by installing static var compensators or other reactive power compensation devices on the grid. Further, failing to maintain sufficient torque to keep the rotor spinning at synchronous speed may result in considerable damage to the generator and/or prime mover.

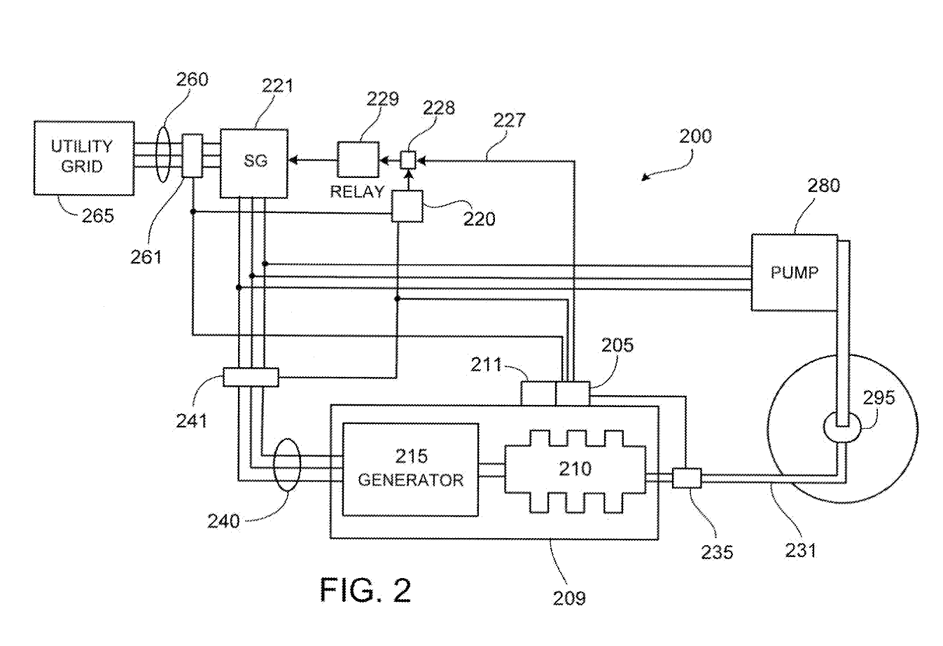

FIG. 2 illustrates an example of power generation system 200 including governor 211 that increases the throttle, and thus, the amount of power generated in response to an increase in available fuel, and vice versa. The availability of fuel is determined based on the flow rate of gas at wellhead 295 or from several wellheads. The flow rate can be measured using sensor circuitry including, for example, a pressure transducer 235 or a flow transducer. The flow rate of fuel to gen-set 209 is controlled to approximate the maximum natural flow from wellhead 295, for example, by adjusting the throttle on engine 210. Thus, an increase in the flow rate of gas from wellhead(s) 295 results in an increase in power generated by gen-set 209.

Power generated by gen-set 209 can be used to meet a demand from a local load such as, for example, pump 280 for extracting oil from an oil producing well. The type of loads may depend on the type of production taking place at the generation site. For example, local loads in oil field production may also include circulating pumps and saltwater injection pumps. Local loads related to natural gas production may include chemical pumps and electric compressors. Further, loads associated with gas plants may also include refrigeration units, compressors, circulating pumps, saltwater injection pumps, and/or chillers. Power not consumed by the local loads may be stored, and/or supplied to utility grid 265, for example, by paralleling power generation system 200 with utility grid 265. Prior to connecting generator 215 to utility power bus 265, however, it is important to synchronize the output voltage waveforms in order to minimize the risk of power surges and potential damage to generator 215. AC voltage waveform characteristics can be measured using sensor circuitry 241 and 261, including, for example, current, voltage, power, and/or VAR transducers. After the frequency, phase angles, and voltage of the generated power are matched to that of utility grid 265, generator power bus 240 is coupled to utility power bus 260 and excess power is supplied to utility grid 265. In this way, wellhead gas is converted into electrical power eliminating the need for flaring, creation of greenhouse gas, and the waste of natural resources. In the case of natural gas wells, converting the gas into electrical power and supplying it to grid 265 avoids the need for piping and/or transporting the gas offsite.

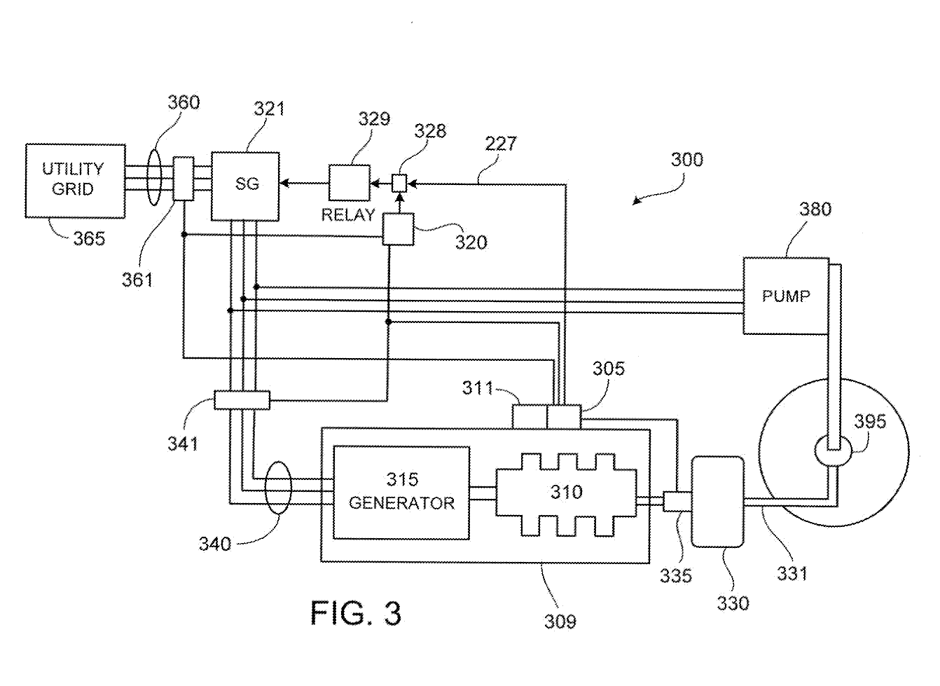

FIG. 3 illustrates power generation system 300 including accumulator tank 330. Although a tank is illustrated in this example, various types of containers could be used such as, for example, a conduit connecting the wellhead vent to the prime mover. In operation, off-gas is captured at wellhead 395 and trapped in the accumulator tank 330. Accumulator tank 330 is used to prevent an instantaneous emptying or voiding of supply line 331 during startup of the prime mover, e.g. natural gas powered internal combustion engine 310, by ensuring a volume of natural gas is available. Pressure sensor 335 monitors the gas pressure in accumulator tank 330 and provides an indication of any change in flow rate from wellhead 395. For example, an increase in pressure indicates the flow rate into accumulator tank 330 is greater than the flow rate out of the accumulator. Similarly, a decrease in pressure indicates the flow rate into accumulator tank 330 is less than the flow rate out of the accumulator. Preferably, the gas pressure in accumulator tank 330 is allowed to reach a pressure which permits maximum gas flow from wellhead 395. The flow of gas from accumulator tank 330 is controlled to vary with the flow from wellhead 395 so that the flow of gas from the accumulator tank approximates maximum natural flow from the wellhead.

The flow of gas can be measured, for example, by flow or pressure transducers. The pressure measurement is converted into a signal that is typically, although not always, analog and which varies with the pressure. A typical pressure transducer provides an output of 4-20 mA and/or 0-10V. However, other output ranges and units could be used corresponding to the particular system interface requirements. This signal may be supplied to a power output regulator of generator 315 to adjust the power output based on changes in the flow of gas being measured. For example, the signal may be amplified and supplied to governor 311 of internal combustion engine 310 to increase or decrease the throttle, and thus the torque applied to generator 315. In some examples, the signal is supplied to an input port of multifunction control module (MCM) 305 which monitors the gas flow and generates control signals to produce the desired response including, for example, increasing or decreasing the power output from the generator in correspondence with increases or decreases in the flow of gas.

The multifunction control module (MCM) may be implemented using analog circuitry and/or logic circuitry. Preferably, the MCM is implemented using a microcontroller such as a programmable logic controller, BASIC Stamp, peripheral interface controller, or other type of logic processor including, for example, microprocessors, FPGAs, ASICs, etc. In addition, the MCM preferably includes a communications port and/or a modem to monitor, adjust, and control the power generation system over a communications network. Further, in some examples, the MCM can be reprogrammed from a remote location. In such cases, the MCM preferably provides a security protected mode in which a system administrator may enter a password to initiate the upload of control software and to flash the controller from a remote location.

In the depicted example, power output is calculated based on measurements taken from generator power bus 340. For example, current is measured using sensor circuitry 341 and 361, including, for example, a current transducer which outputs a 4-20 mA DC signal corresponding to the measured current. Voltage is also measured using sensor circuitry 341 and 361, for example, by down-converting a voltage signal using step down transformers. The DC current and voltage signals are supplied to input ports of MCM 305 which calculates the power being generated. Power output may be measured in other ways. Preferably, power output is measured using a WATT-VAR transducer. MCM 305 uses these signals to monitor other output characteristics including, for example, phase angle, phase rotation, and/or frequency. These measurements may also be used to detect fault conditions including, for example, over-voltage, under-voltage, over-current, under-current, phase balance, voltage balance, reverse power flow, and/or unacceptable reactive current. Similar techniques may be used to monitor the power characteristics of utility power bus 360 and to detect fault conditions occurring on utility grid 365.

Wellhead gas, such as from an oil producing or natural gas well, is used to power a prime mover which drives generator 315. However, as described above, the output of generator 315 is not determined by the demand from load 380. Rather, when operating in cogeneration mode, the power output is determined by the rate of flow of gas from wellhead 395. Preferably, the prime mover, e.g., natural gas powered internal combustion engine 310 is driven to utilize the maximum gas flow available, eliminating the need to vent or flare the gas.

The electrical power produced can be used directly to drive pumps 380 or other devices, stored, and/or fed into electrical utility grid 365. The generated power output may also be used to complement utility-provided power so that when the electrical power produced is insufficient to satisfy pumping requirements, the necessary additional power is taken from utility grid 365. When the power generated exceeds local demands, the excess power is fed into utility grid 365 and/or stored.

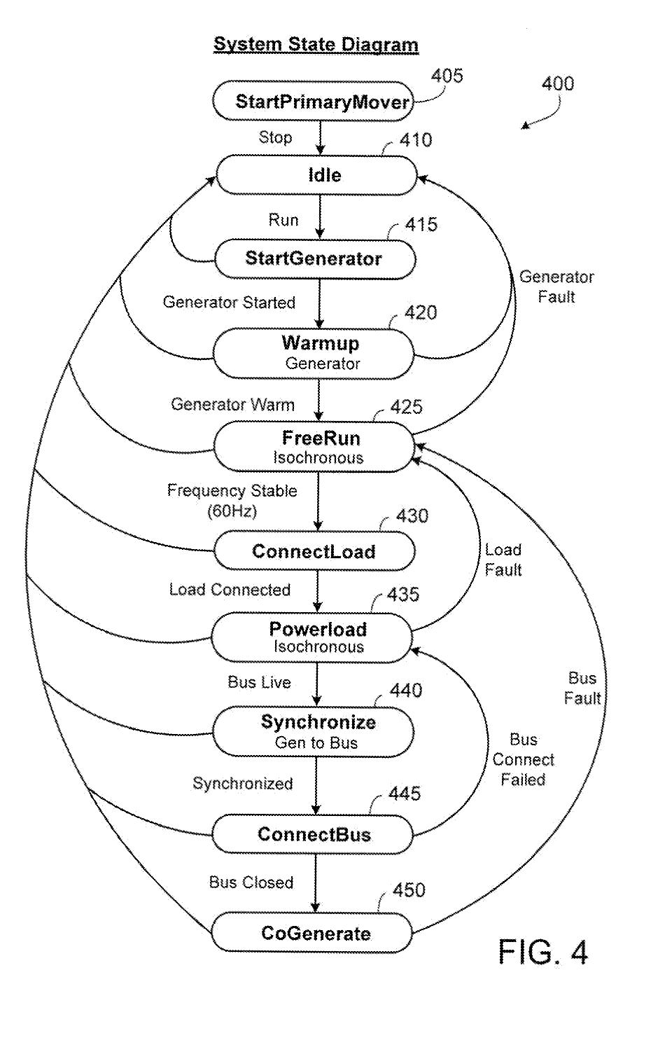

FIG. 4 is a system state diagram 400 describing an exemplar operation of a power generation system. Subsequent figures will depict details of the operation with respect to power generation system 200, however the events and the sequence of those events may be modified to correspond to the components, features, and capabilities of the target power generation system.

As illustrated in FIG. 4, the prime mover, for example, natural gas powered internal combustion engine 210, is first started and set to idle prior to engaging the generator as depicted in process block 410. Startup fuel for engine 210 may be provided from an auxiliary tank, wellhead gas, or from gas reserves in an accumulator. In some examples, utility grid power may be supplied to pump 280 prior to switching over to local generation. MCM 205 monitors engine 210 and adjusts the fuel flow to a desired set point prior to engaging generator 215. After the set point is reached, generator 215 is engaged, as depicted in process block 415, and generator 215 is allowed to warm up 420 for a period of time as determined by MCM 205. Preferably, MCM 205 gradually steps up the rotation speed of generator 215 allowing MCM 205 to monitor the response of frequency to the change in speed in order to confirm the system 200 is operating as expected. After the period of time has elapsed, power generation system 200 enters into a freerun state 425.

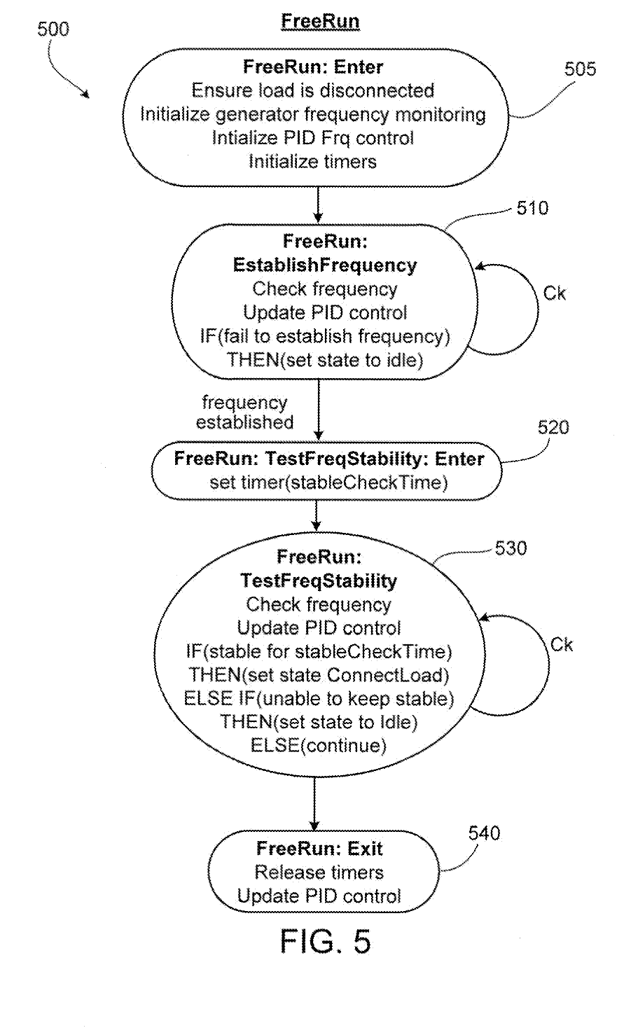

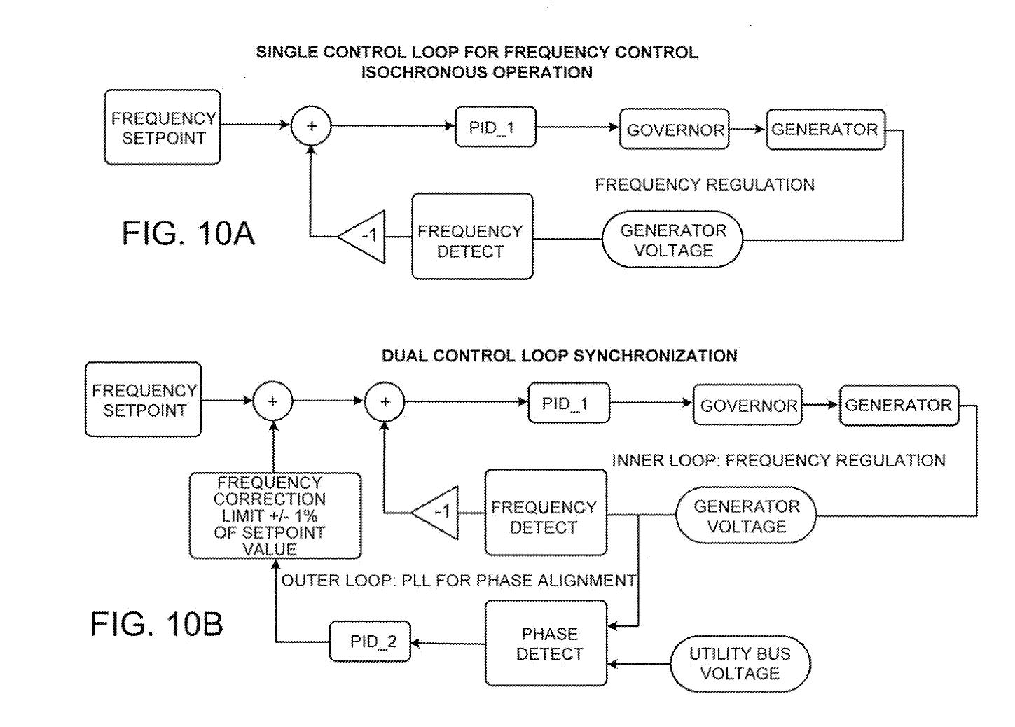

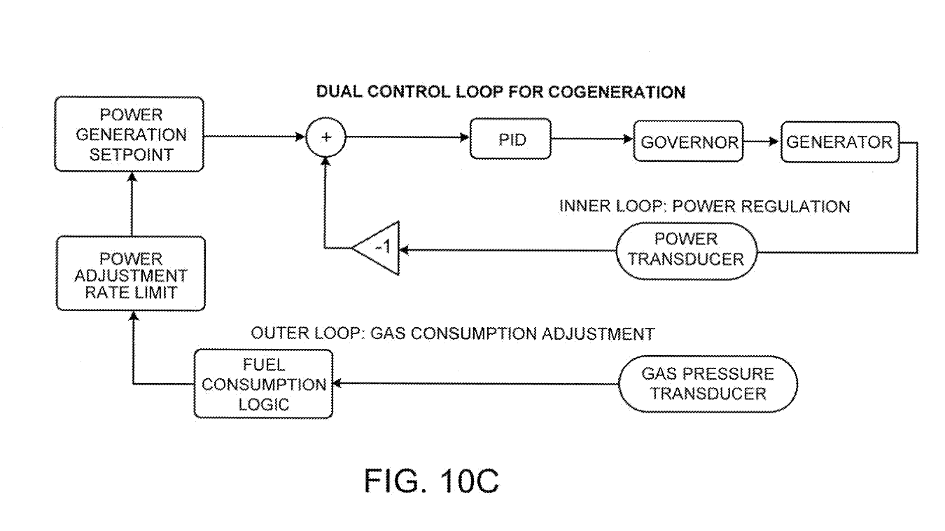

FIG. 5 is a system state diagram 500 describing the freerun state 425 for an example of a power generation system, such as, for example, power generation system 200. As indicated, MCM 205 verifies no load is connected to the generator power bus 240 and proceeds to monitor the frequency of the power produced by generator 215, as depicted in process block 505. MCM 205 is configured to implement a control loop feedback mechanism, e.g. a PID control algorithm as illustrated in FIG. 10A, to reduce the error between the measured frequency and a desired set point by calculating and then outputting a control signal 213 (not shown) to adjust the speed of generator 215, as depicted in process block 510. For example, MCM 205 generates a pulse width modulated signal having a variable duty cycle. Signal 213 is amplified and transmitted to governor 211 of engine 210 to increase or decrease the throttle. An increase or decrease in the duty cycle results in a corresponding increase or decrease in speed.

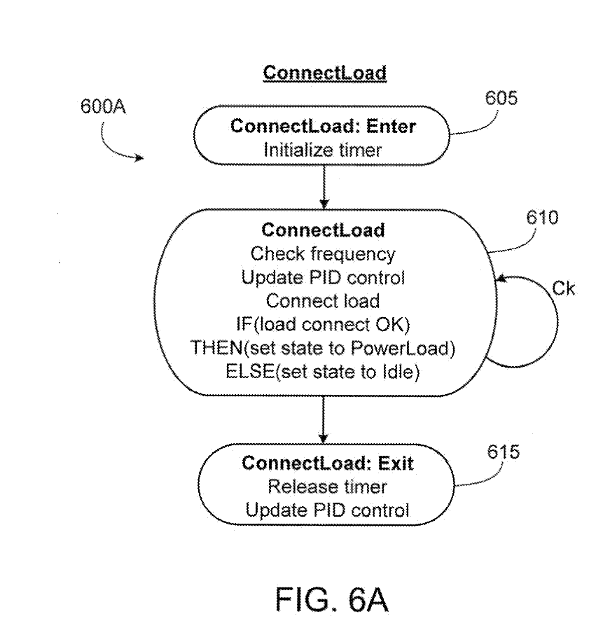

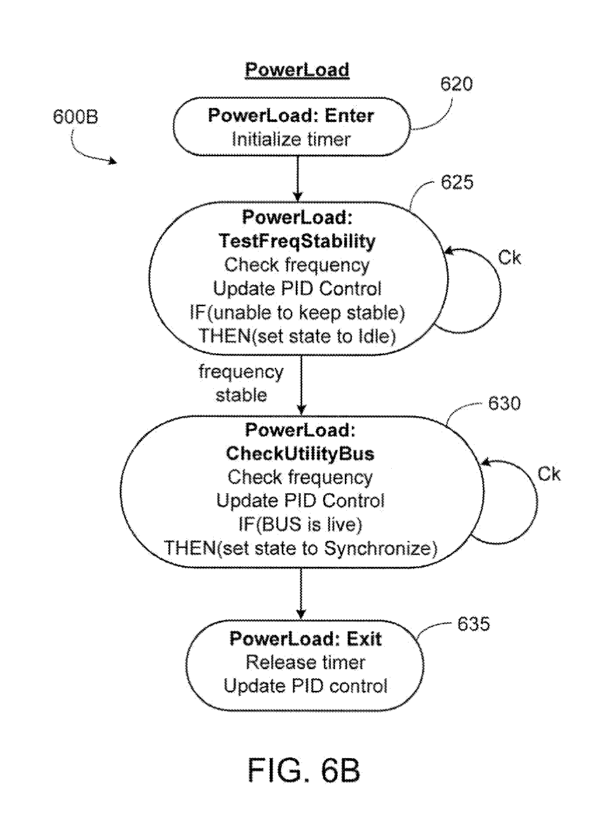

In some examples of process block 430 of FIG. 4, MCM 205 engages a local load, for example, by closing an auxiliary switch to couple the load, for example, load 280, to generator power bus 240 after the desired frequency is attained and remains stable. FIG. 6A is an exemplar system state diagram 600A for connecting a load. In some instances, it may be necessary to first disconnect the load from utility power bus 260 or to synchronize the generated power with the utility power as described below. FIG. 6B is an exemplar system state diagram 600B for powering the load. As indicated in process block 625, MCM 205 continues to monitor and adjust the power frequency to compensate for any drift after the load has been connected.

A sudden increase or decrease in demand from the load increases/decreases real current quantities imposed on the stator windings of the generator. The corresponding change in flux allows the rotor shaft to accelerate or decelerate due to the torque change. Conventional systems sense the frequency spike and/or the change in speed before attempting to modify the governor setting, thus causing a long delay, large frequency spikes, and associated wear and tear on the generator and/or prime mover. A typical power generation system will sense the decrease in speed and/or frequency and attempt to compensate. However, the delay between the detection of the event and the occurrence of the event results in noticeable fluctuations on the power output, such as frequency spikes. In order to minimize this effect, MCM 205, in some implementations, includes a load change anticipation and compensation system (LCACS) 206 which monitors the current being drawn from generator 215 for any sudden increase or decrease and modifies the characteristics of control signal 213 (as calculated by LCACS 206 depending on the magnitude and duration of the disturbance) in such a way as to counter the acceleration or deceleration of the rotor as anticipated by the sensed magnitude and duration of the disturbance. For example, in the case where control signal 213 is a pulse width modulated signal having a variable duty cycle, the duty cycle of control pulses, as calculated to maintain constant frequency is augmented (increased or decreased) in proportion to the characteristics of the disturbance. In one example, LCACS 206 includes wire wound resistors placed on the secondary windings of the current transducer(s) of sensor circuitry 241 to sense the disturbance. Current flowing through the resistors provides a voltage drop across the resistor which can be measured and provided to MCM 205, or from which a current can be calculated based on the known resistance value. Preferably, low resistance, high accuracy resistors are used. In some implementations, the resulting voltages produced on the sensing resistors are sent through an analog signal processing subsystem that conditions the signal into a DC representation of the difference in the magnitude of the stator current. The conditioned signal is sent to MCM 205 where it is factored into the pulse width modulated duty cycle calculation. Although LCACS 206 is implemented in MCM 205 for this example, LCACS 206 may also be implemented using logic circuitry external to MCM 205.

Measuring voltage and/or calculating the current as opposed to monitoring the rotor or engine speed reduces the response time of MCM 205 to the load fluctuation. In some cases, the response time is reduced from 32 msec to 4 msec. In such a case, power generation system 200 is able to compensate for these fluctuations within a quarter cycle as opposed to two cycles in a 60 Hz system, for example. In a 50 Hz system, the response time is reduced from 40 msec to 5 msec.

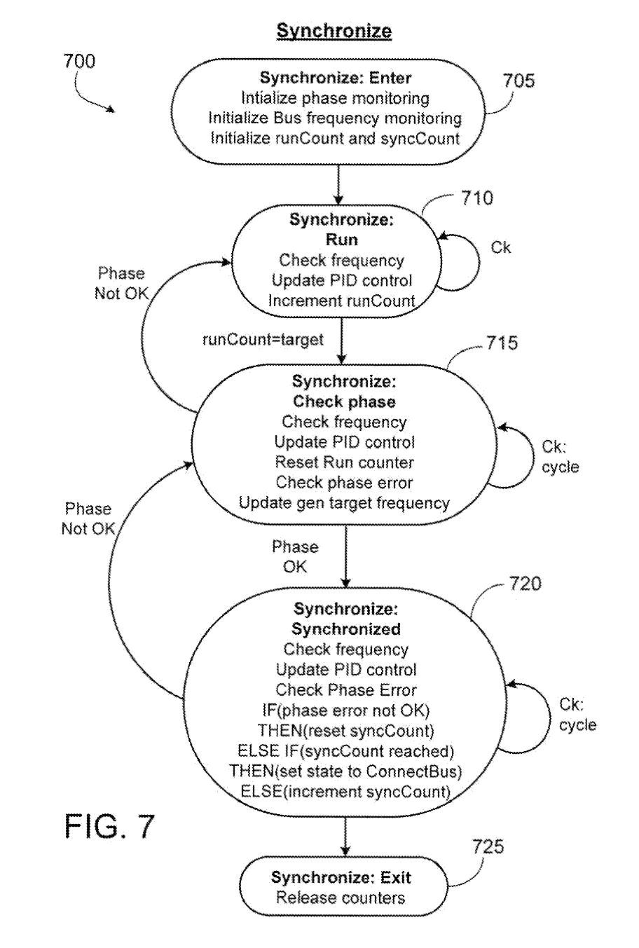

In some examples of process block 435 of FIG. 3, after MCM 205 determines the power output is stable, the utility power 260 will be monitored for a period of time (which may be predetermined, calculated, or random) to ensure the bus is live and stable. In some examples of process block 440 of FIG. 4, after MCM 205 determines both buses 240 and 260 are stable, power generation system 200 enters a synchronization sequence as depicted at process block 630 of FIG. 6B. FIG. 7 is an exemplar system state diagram 700 for synchronizing the power generated by generator 215 to utility power bus 260. The synchronization process matches the output voltage waveforms of generator 215 to the voltage waveform of utility grid 265. Automatic synchronization logic adjusts the frequency of the power produced by generator 215 to match the phase angle to that of utility power bus 720. FIG. 10 illustrates an example PID algorithm executed by the automatic synchronization logic. The automatic synchronization logic may be implemented in MCM 205, for example, by executing a PID control algorithm based on feedback from phase lock loop circuitry used to detect phase alignment. When entering the synchronization sequence, MCM 205 implements the PID algorithms shown in FIG. 10B, for example.

As shown in FIG. 10B, sensor circuitry 241 and 261 include phase detectors which receive voltage waveforms from generator power bus 240 and utility power bus 260. The outputs of the phase detectors are fed into a correction algorithm which outputs a frequency correction value within an acceptable range of frequencies, e.g., +/−1% of the initial frequency setpoint. In this way, the frequency setpoint will be adjusted in small increments in order to effect a shift in phase alignment until the desired phase alignment is achieved.

Switchgear 221 is coupled to generator power bus 240 and utility power bus 260. Some implementations may include multiple switchgears 221, breakers, and/or fuses for increased protection. Switchgear control relay 229 is connected to engage or disengage switchgear 221, thus coupling or decoupling power buses 240 and 260. For example, MCM 205 may issue a close command by energizing switchgear control relay 229 which in turn engages switchgear 221, coupling the two buses. Any interruption in control signal 227 from MCM 205 to switchgear control relay 229 would de-energize relay 229 and trip switchgear 221 causing generator power bus 240 to be decoupled from utility power bus 260.

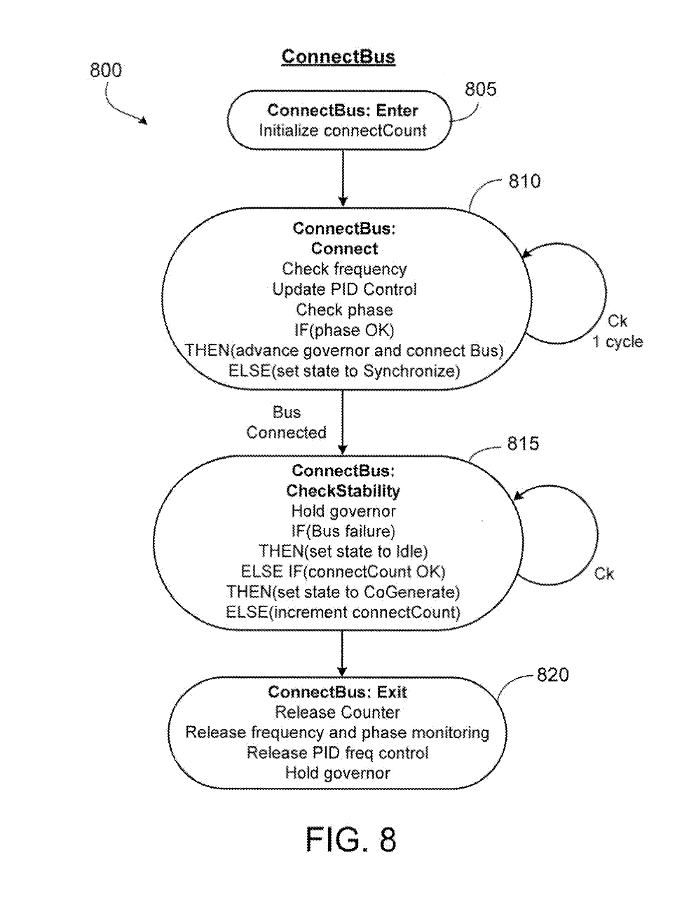

FIG. 8 illustrates an exemplar bus connection sequence 800, for example as might be used in some examples of process block 445 of FIG. 4. As shown, after the frequency and phase angles detected on generator power bus 240 are matched to those of utility power bus 260, power generation system 200 proceeds to the bus connection sequence depicted in FIG. 8. Prior to initiating a close command to switchgear 221, MCM 205 advances governor 211 to increase the speed slightly above the frequency of utility power bus 260, as depicted in process block 810. This is done to reduce the risk of the rotor speed dropping below the speed necessary to match the utility grid frequency and thus, drawing real and reactive power from the grid 265. In initiating the close command, MCM 205 transmits control signal 227 to switchgear control relay 229. After switchgear 221 is engaged, the speed of the generator rotor will slow as it is locked into synchronous speed and the additional torque provided by holding the governor at the advanced position will be converted into current by generator 215 as depicted by process block 815. MCM 205 next monitors the power output for a period of time (which may be predetermined, calculated, or random) while maintaining a positive torque on generator 215.

In some examples, protective relay system 220 monitors the voltage, current, frequency and phase angles of the power on generator power bus 240 and the utility power bus 260. Protective relay system 220 includes a switch 228 connected in series between switchgear control relay 229 and MCM 205. If protective relay system 220 and MCM 205 agree that a match exists between the AC voltage waveform characteristics being monitored, switch 228 is closed, completing the circuit, and control signal 227 from MCM 205 is allowed to energize switchgear control relay 229. In some implementations, tolerance limits are set for the comparison of waveform characteristics. In each of the examples described above and below, a perfect match between the waveform characteristics is not necessary. As mentioned above, a slight increase in frequency may be desirable to establish a desired positive slip when coupling a generator to the utility grid to ensure a positive torque is maintained on generator 215.

Protective relay system 220 may also monitor a variety of other parameters including, for example, line faults, over-voltage conditions, under-voltage conditions, over-frequency, under-frequency, phase balance in a multiphase systems, reverse power flow, and/or reactive current. Responsive to these measurements, the MCM and/or protective relay system 220 may trip switchgear 221 by terminating control signal 227 provided to switchgear control relay 229, for example, by opening switch 228.

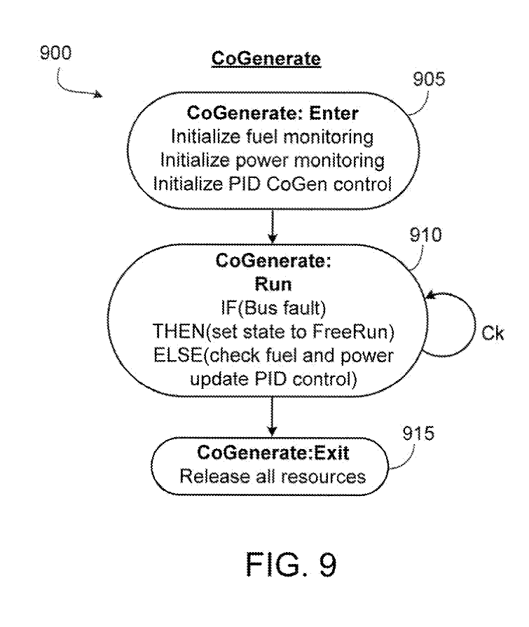

Referring once again to FIG. 4, upon successful completion of the bus connection sequence 445, power generation system 200 enters cogeneration mode 450, an example of which is depicted in greater detail in FIG. 9. As shown in FIG. 9, in cogeneration mode, MCM 205 maintains a desired gas pressure in conduit 231, or optional accumulator 330, by controlling governor 211 on engine 210 as depicted in process block 910. For example, MCM 205 is configured to implement a control loop feedback algorithm to reduce the error between the measured pressure and a desired set point by calculating and then outputting a control signal to adjust the throttle on engine 210.

An exemplar control loop feedback algorithm is illustrated in FIG. 10C. As illustrated, the power generated by generator 215 is measured using sensor circuitry 241 including, for example, a power transducer. The output of the power measurement taken from the power transducer is then used to calculate a correction value to increase or decrease the power generated to match the power generation setpoint. In this example, the power generation setpoint is preferably set to a value at which the fuel consumption matches the flow rate of gas available from the wellhead as measured the gas pressure transducer.

As described previously, an increase in throttle results in an increase in fuel flow from the conduit, and vice versa. In the depicted example of FIG. 2, a pulse width modulated signal having a variable duty cycle is generated by MCM 205. The signal is amplified and transmitted to the governor to increase or decrease the throttle. Because the speed of the rotor is held constant, the additional throttle produces an increase in torque which results in an increase in power generated by generator 215. Thus, an increase or decrease in the duty cycle of the pulse width modulated signal results in a corresponding increase or decrease, respectively, in power generated. Although the examples described above and below include a pulse width modulated control signal having a variable duty cycle, other types of control signals could be applied corresponding to the speed control circuitry interface requirements.

In some implementations, MCM 205 compares the fuel pressure to an upper limit and a lower limit. For example, the upper limit may be set to correspond with the maximum flow rate the prime mover will accept. Preferably, the prime mover is selected so as to be able to consume fuel at the maximum flow rate expected at the source of the gas. When the pressure exceeds the upper limit for a period of time (which may be predetermined, calculated, or random), the MCM initiates appropriate actions to compensate, for example, by starting up an additional generator. The lower limit may be set to correspond to a level estimated to provide the minimum flow necessary to generate enough power to meet the local demand. In some examples, the lower limit may be set to correspond to a level estimated to provide the minimum flow necessary to maintain a positive torque on the generator. Upon detecting the pressure has dropped below the lower limit for a period of time (which may be predetermined, calculated, or random), MCM 205 terminates control signal 227 to switchgear control relay 229, tripping switchgear 221 and disengaging generator 215 from utility power bus 260. In some examples (for example some preferred implementations discussed below), the local load (for example, pump 280) draws power from the utility power bus (for example, 260) when the fuel pressure drops below the lower limit.

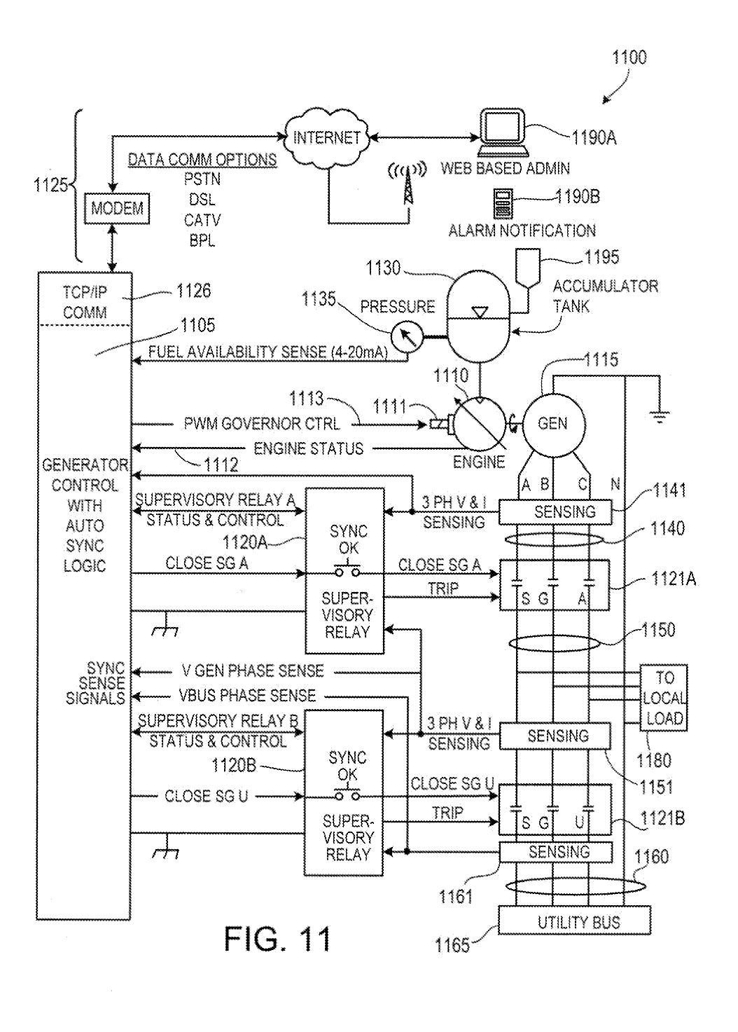

FIG. 11 is an example of automated power generation control system 1100. The system includes MCM 1105 with a preferred automatic synchronization logic, engine 1110 coupled with generator 1115, supervisory relays 1120A and 1120B, switchgears 1121A and 1121B, and communication system 1125. Accumulator 1130 is coupled with pressure sensor 1135, e.g. a pressure transducer which outputs a DC signal to MCM 1105. The output of pressure sensor 1135 is typically a variable DC current with a range of 4-20 mA being preferred but it may be expressed with other ranges and/or units. The pressure signal provides an indication of the flow of gas into and out of accumulator tank 1130, and thus, fuel availability. Accumulator tank 1130 is optional and not a required part of the exemplar system. For example, pressure sensor 1135 may be connected directly to the conduit supplying the fuel. The fuel is provided to engine 1110, for example, a natural gas powered internal combustion engine, which is coupled to generator 1115. Engine 1110 includes governor 1111 which receives a signal 1113 from MCM 1105 to advance or retard the speed of engine 1110. As previously discussed, signal 1113 is preferably a pulse width modulated signal. Engine performance is monitored by MCM 1105 via engine status bus 1112. Multiple engine parameters are preferably monitored including, for example, temperature, speed, and/or oil pressure. Generator 1115 is coupled to generator power bus 1140. Generator power bus 1140 is monitored by supervisory relay 1120A including sensor circuitry 1141 capable of sensing, for example, voltage, current, frequency, and/or phase of the power produced by generator 1115. Supervisory relay 1120A also is connected to sensor circuitry 1151 to monitor common bus 1150 which is coupled to the switchgear(s) and a local load. In this example, common bus 1150 is initially powered by a primary generator (not shown) prior to generator 1115 coming on line. Common bus 1150 is also monitored by MCM 1105 using sensor circuitry 1151. The MCM 1105 will advance or retard generator 1115 to synchronize the output voltage waveforms between buses 1140 and 1150. After MCM 1105 determines the power output from generator 1115 is synchronized with common bus 1150, MCM 1105 will issue a close command. If the supervisory relay 1120A also detects that buses 1140 and 1150 are synchronized, supervisory relay 1120A will close allowing the transmission of the close command to switchgear 1121A.

Second switchgear 1121B and supervisor relay 1120B are also shown in FIG. 11. Switchgear 1121B is coupled to utility power bus 1160 and common bus 1150. Supervisory relay 1120B monitors common bus 1150 and utility power bus 1160 and closes when synchronization is detected. Sensor circuitry 1161 and 1151 provide waveform characteristic information to supervisory relay 1120B and MCM 1105. MCM 1105 monitors the buses 1160 and 1150 advancing or retarding governor 1111 on engine 1110 to synchronize the power output from generator 1115 to that of utility power bus 1160. Preferably, a single MCM 1105 provides governor control signals 1113 to each of the one or more engines 1110, supplying power to common bus 1150 to maintain synchronous output for each of the one or more generators 1115. In some cases, it may be preferable to have an individual MCM 1105 for each of the one or more generators 1115, for example, in implementations where large distances separate generators 1115 connected to common bus 1150. In such cases, preferably, communication network 1125 is provided linking MCMs 1105 to improve response time and control over the power on common bus 1150, especially when attempting to synchronize the power off common bus 1150 to that of utility power bus 1160.

After the power on common bus 1150 is synchronized, supervisory relay 1120B will close and MCM(s) 1105 will issue a close command to the corresponding switchgear 1121B. As described above, the generator power output is adjusted in response to the fuel availability. In this example, accumulator tank 1130 may be coupled to provide fuel to one or more engines 1110 increasing the amount of fuel that can be consumed to match the amount of fuel available, for example, from a natural gas or oil producing wellhead.

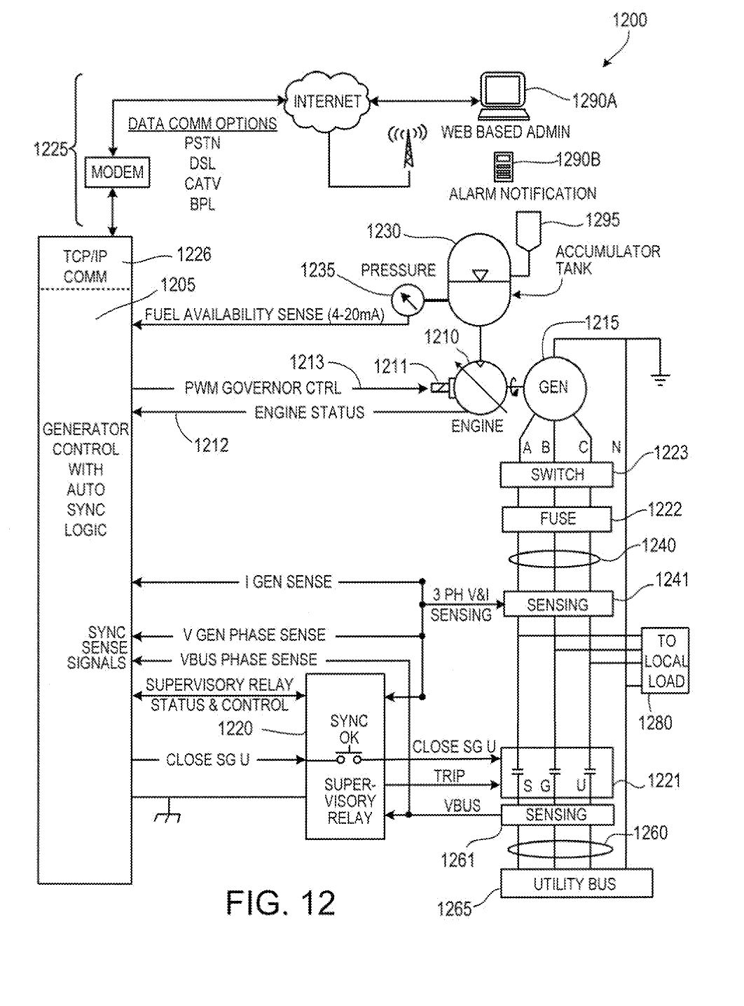

FIG. 12 is an example of automated power generation control system 1200 with a fused generator. System 1200 includes MCM 1205 with a preferred automatic synchronization logic, engine 1210 coupled with generator 1215, auxiliary switch 1223, supervisory relay 1220, switchgear 1221, and communication system 1225. Accumulator 1230 is coupled with pressure sensor 1235, e.g. a pressure transducer which outputs, for example, a DC signal to the MCM 1205. Pressure sensor 1235's output signal is depicted as being between 4 and 20 mA but it may be expressed in a different range or denominated in different units. The pressure signal provides an indication of the flow of gas into and out of the optional but preferred accumulator tank, and thus, fuel availability. The fuel is provided to engine 1210, for example, a natural gas powered internal combustion engine, which is coupled to generator 1215. Engine 1210 includes governor 1211 which receives control signal 1213 from MCM 1205 to advance or retard the speed (i.e., when in Isochronous mode) or torque (i.e., when in Cogeneration mode) of engine 1210. Preferably, control signal 1213 is a pulse width modulated signal having a variable duty cycle. Engine performance, including, for example, temperature, speed, and/or oil pressure is monitored by MCM 1205 via engine status bus 1212.

In FIG. 12, generator 1215 is coupled to generator power bus 1240 via auxiliary switch 1223 and in-line fuses 1222. Generator power bus 1240 is monitored by MCM 1205 via sensor circuitry 1241 including, preferably, a power transducer to measure the power on the generator power bus 1240. Generator power bus 1240 is coupled to local load 1280 and switchgear 1221 which is connected to utility power bus 1260. In this example, both MCM 1205 and supervisory relay 1220 monitor generator power bus 1240 for faults and for synchronization with utility power bus 1260. MCM 1205 advances or retards generator 1215 within acceptable frequency limits to synchronize the output voltage waveforms between buses 1240 and 1260. Upon determining that the power output from generator 1215 is synchronized with utility power bus 1260, MCM 1205 will issue a close command. If supervisory relay 1220 also detects that buses 1240 and 1260 are synchronized, supervisory relay 1220 will close allowing the transmission of the close command to switchgear 1221.

MCM 1205 and supervisory relay 1220 will continue to monitor the frequency, phase alignment, and various other parameters, and will trip switchgear 1221 upon the detection of a fault condition. As described above, the generator power output is adjusted in response to the fuel availability. If MCM 1205 detects an insufficient amount of fuel available to maintain a positive torque on generator 1215, MCM 1205 will open auxiliary switch 1223 disengaging generator 1215 from generator power bus 1240 and load 1280. Under normal conditions, load 1280 will continue to be powered by utility power bus 1260 until sufficient fuel is available to re-engage generator 1215 and reinitialize system 1200 by tripping switchgear 1221 and closing auxiliary switch 1223 to reestablish synchronization between power buses 1240 and 1260.

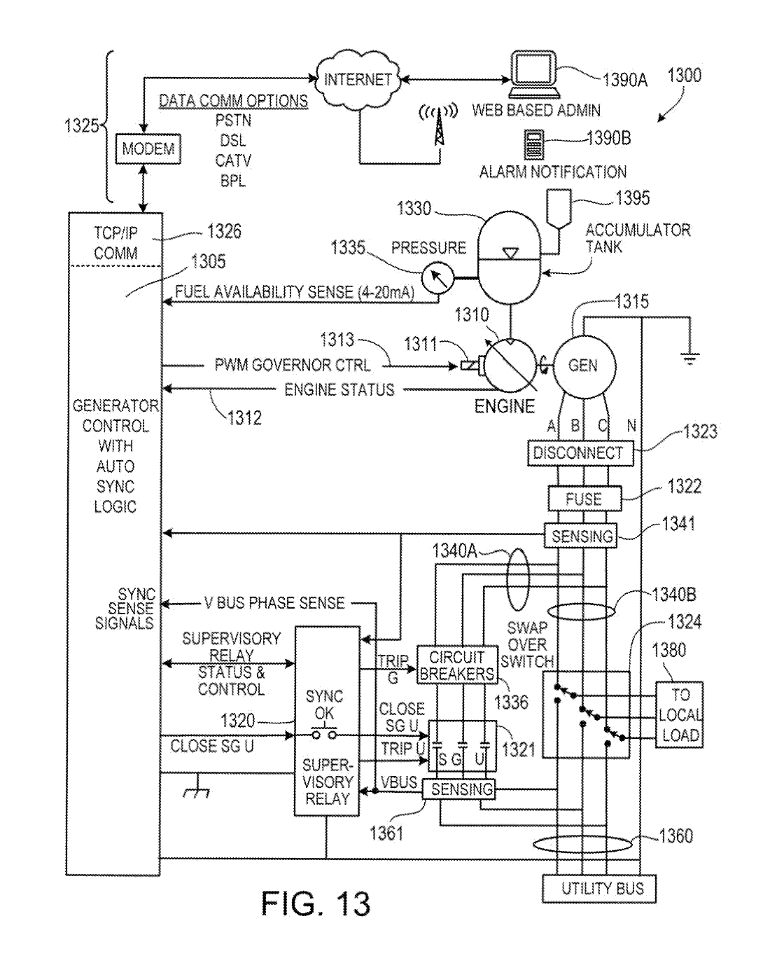

FIG. 13 is an example of an automated power generation control system 1300 with a hybrid protection arrangement including swap-over switch 1324. The system includes MCM 1305 with a preferred automatic synchronization logic, engine 1310 coupled with generator 1315, supervisory relay 1320, switchgear 1321, swap-over switch 1324, and communication system 1325. Optional accumulator 1330 is coupled with pressure sensor 1335, e.g. a pressure transducer which outputs a DC signal to the MCM 1305. Pressure sensor 1335's output signal is again depicted as being between 4 and 20 mA but it may be expressed as a different range or be denominated in different units. The pressure signal provides an indication of the flow of gas into and out of accumulator tank 1330, and thus, fuel availability. The fuel is provided to the engine 1310, for example, a natural gas powered internal combustion engine, which is coupled to generator 1315. Engine 1310 includes governor 1311 which receives control signal 1313 from MCM 1305 to advance or retard the speed of engine 1310. Preferably, control signal 1313 is a pulse width modulated signal having a variable duty cycle. Engine performance, including, for example, temperature, speed, and/or oil pressure is monitored by the MCM via engine status bus 1312.

Generator 1315 in FIG. 13 is coupled to generator power bus 1340 via auxiliary switch 1323 and in-line fuses 1322. The generator power bus 1340 includes primary branch 1340A and secondary branch 1340B. Generator power bus 1340 is monitored by MCM 1305 via sensor circuitry 1341 including a power transducer to measure the power generated by generator 1315. Primary branch 1340A is connected to circuit breakers 1336 controlled by supervisory relay 1320. Supervisory relay 1320 will trip circuit breakers 1336 when an earth fault or overcurrent condition is detected. Switchgear 1321 is coupled to circuit breakers 1336 and generator power bus 1340 and to utility power bus 1360. MCM 1305 and supervisory relay 1320 monitor primary branch 1340A for faults and for synchronization with utility power bus 1360. The automatic synchronization logic in MCM 1305 will advance or retard generator 1315 within acceptable frequency limits to synchronize the output voltage waveforms between buses 1340 and 1360. Upon determining the power output from generator 1315 is synchronized with utility power bus 1360, MCM 1305 will issue a close command. If supervisory relay 1320 also detects that buses 1340 and 1360 are synchronized, supervisory relay 1320 will close allowing the transmission of the close command to switchgear 1321.

Generator power bus 1340 in FIG. 13 also includes secondary branch 1340B which is coupled to swap-over switch 1324. Swap-over switch 1324 enables local load 1380 to be connected directly to utility power bus 1360, bypassing switchgear 1321. In this way, local load 1380 can draw power from utility power bus 1360 during the initial startup sequences and during abnormal conditions or maintenance cycles.

Prior to starting power generation system 1300, utility power may be used to power local load 1380 such as, for example, pumps to extract oil from an oil producing well or natural gas from a natural gas wellhead. As mentioned above, off-gas produced from an oil producing well can be captured and supplied to engine 1310 as fuel. Similarly, natural gas from a natural gas wellhead can be captured and supplied to engine 1310 as fuel.

At startup, MCM 1305 starts engine 1310 and adjusts governor 1311 to maintain engine 1310 in an idle state. In some implementations, the startup fuel for engine 1310 may alternatively be provided from an auxiliary tank or from gas reserves in accumulator 1330. MCM 1305 monitors engine 1310 via engine status bus 1312 and adjusts the fuel flow to a desired set point prior to engaging generator 1315. After the set point is reached, generator 1315 is engaged and is allowed to warm up for a period of time as determined by MCM 1305. After the period of time has elapsed, power generation system 1300 enters into a freerun state in which MCM 1305 monitors the frequency of the power produced by generator 1315 after verifying no load is connected. MCM 1305 implements a PID control algorithm to reduce the error between the measured frequency and a desired set point by calculating and then outputting control signal 1313, e.g., a pulse width modulated control signal having a variable duty cycle, to adjust the speed of generator 1315. Signal 1313 is amplified and transmitted to governor 1311 of engine 1310 to increase or decrease the throttle until the desired frequency is produced. An increase or decrease in the duty cycle of the pulse width modulated signal results in a corresponding increase or decrease in speed. Increasing or decreasing the speed of engine 1310 changes the speed of the rotor within generator 1315, thus affecting the frequency.

After a period of time (which may be predetermined, calculated, or random), MCM 1305 will issue a swap-over command transferring load 1380 from utility power bus 1360 to generator power bus 1340. MCM 1305 includes load change anticipation and compensation system (LCACS) 1306. LCACS 1306 monitors the current being drawn from generator 1315 for any sudden increase or decrease and modifies the characteristics of control signal 1313 to counter the anticipated acceleration or deceleration of the rotor resulting from load disturbances. The duty cycle of control signal 1313 is augmented (increased or decreased) in proportion to the characteristics of the disturbance. LCACS 1306 includes low resistance, high accuracy wire wound resistors placed on the secondary windings of the current transducer(s) of sensor circuitry 1341 to sense the disturbance. The resulting voltages produced on the sensing resistors are sent through an analog signal processing subsystem that conditions the signal into a DC representation of the difference in the magnitude of the stator current. The conditioned signal is sent to MCM 1305 where it is factored into the pulse width modulated duty cycle calculation. Measuring the current as opposed to the rotor or engine speed has been found to improve the response time and, in some instances, from approximately 32 msec (2 cycles) to approximately 4 msec (quarter cycle) in a 60 Hz system, and from approximately 40 msec (2 cycles) to approximately 5 msec (quarter cycle) in a 50 Hz system.

After MCM 1305 determines that power output is stable, the automatic synchronization logic matches the output voltage waveforms of generator 1315 to the voltage waveform of the utility grid. The automatic synchronization logic adjusts the frequency and phase angle of the power produced by generator 1315 to match the frequency and phase angle present on utility power bus 1360 by adjusting pulse width modulated control signal to governor 1311. After the frequency and phase angles detected on generator power bus 1340 are matched to that of utility power bus 1360, MCM 1305 advances governor 1311 to increase the speed slightly above the frequency of utility power bus 1360. As mentioned previously, this is done to reduce the risk of the rotor speed dropping below the speed necessary to match the utility grid frequency and thus, drawing reactive power from the grid. MCM 1305 then attempts to energize switchgear control relay 1329. If supervisory relay 1320 also determines that buses 1340 and 1360 are synchronized and no fault condition exists, supervisory relay 1320 closes, completing the circuit and allowing MCM 1305 to energize switchgear control relay 1329.

After switchgear 1321 is engaged, the speed of the generator rotor will slow as it is locked into synchronous speed and the additional torque provided by holding governor 1311 at the advanced position will be converted into current by generator 1315. MCM 1305 preferably monitors the power output for a period of time (which may be predetermined, calculated, or random) while maintaining a positive torque on generator 1315. Supervisory relay 1320 monitors a variety of parameters including, for example and preferably, line faults, over-voltage conditions, under-frequency, over-frequency, under-voltage conditions, phase balance, voltage balance, reverse power flow, and/or reactive current. Responsive to these measurements, MCM 1305 and/or supervisory relay 1320 may disconnect generator 1315 from utility power bus 1360 by tripping switchgear 1321, auxiliary switch 1323, and/or circuit breakers 1336.

In cogeneration mode, MCM 1305 maintains a desired pressure in accumulator 1330 by controlling governor 1311 on engine 1310. For example, MCM 1305 reduces the error between the measured pressure and the desired set point by calculating and adjusting control signal 1313, which is preferably adjusted by changing the duty cycle of a pulse width modulated control signal. Control signal 1313 is amplified and transmitted to governor 1311 of engine 1310 to increase or decrease the flow of fuel to engine 1310, for example, by adjusting the throttle, to maintain the desired pressure. As explained above, the speed of the rotor is held constant when generator 1315 is synchronized with the utility grid. Thus, the additional throttle produces an increase in torque which results in an increase in power generated by generator 1315.

MCM 1305 compares the fuel pressure to an upper limit corresponding to the maximum flow rate the engine will accept. Preferably, engine 1310 is selected so as to be able to consume the maximum flow expected at the source of the gas. When the pressure exceeds the upper limit for a period of time (which may be predetermined, calculated, or random), MCM 1305 may compensate, for example, by initiating a start up sequence for a second generator. In some examples, MCM 1305 compares the fuel pressure to a critical limit corresponding to a level estimated to provide the minimum flow necessary to maintain a positive torque on generator 1315. Upon detecting the pressure has dropped below the critical limit, the MCM 1305 disconnects generator 1315 from utility power bus 1360 by tripping switchgear 1321 and/or by opening auxiliary switch 1323. Load 1380 will continue to be powered by utility power bus 1360 until sufficient fuel is available to re-engage generator 1315 and reinitialize system 1300.

While the pressure remains within the limits, MCM 1305 will adjust the generator power output in response to the fuel availability. MCM 1305 and supervisory relay 1320 will continue to monitor the frequency, phase alignment, and various other parameters, and will trip switchgear 1321 and/or breakers 1336 upon the detection of a fault condition which may include, for example, under-voltage, over-voltage, undercurrent, overcurrent, phase imbalance, under frequency, voltage imbalance, reverse power, and/or unacceptable reactive current.

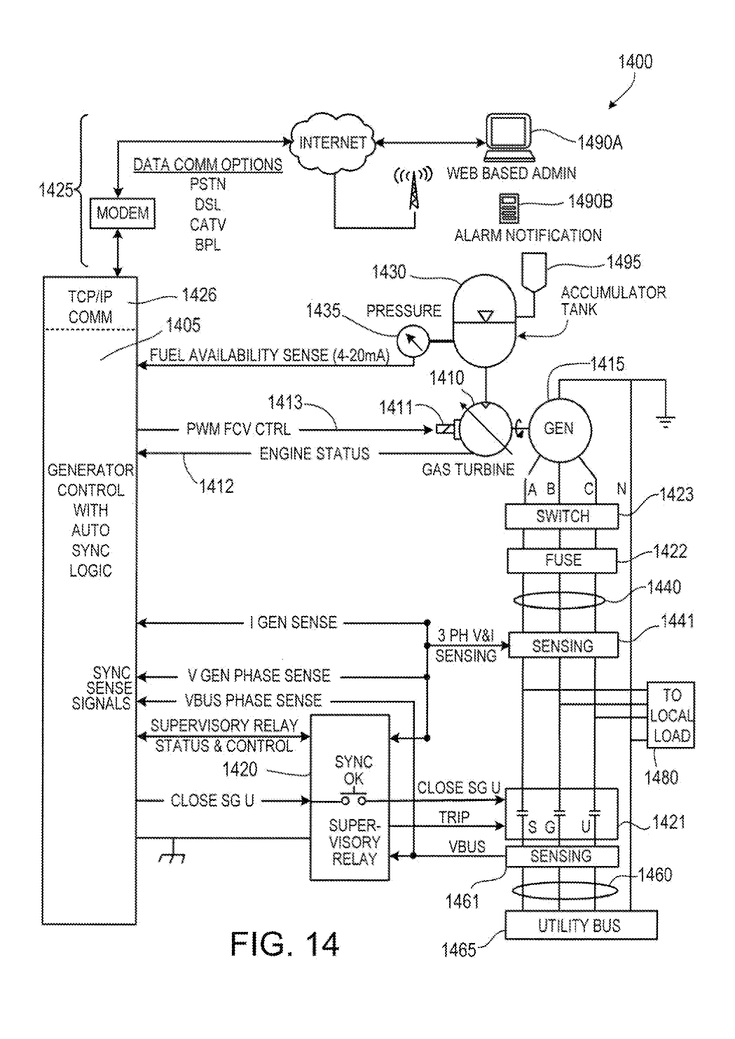

FIG. 14 is an example of automated power generation control system 1400 with a fused generator. System 1400 includes MCM 1405 with a preferred automatic synchronization logic, gas turbine 1410 coupled with generator 1415, auxiliary switch 1423, supervisory relay 1420, switchgear 1421, and communication system 1425. Optional accumulator 1430 is coupled with pressure sensor 1435, e.g. a pressure transducer which outputs, for example, a DC signal to the MCM 1405. Pressure sensor 1435's output signal is depicted as being between 4 and 20 mA but it may be expressed in a different range or denominated in different units. The pressure signal provides an indication of the flow of gas into and out of the accumulator tank, and thus, fuel availability. The fuel is provided to turbine 1410 which is coupled to generator 1415. Turbine 1410 includes fuel control valve 1411 which receives control signal 1413 from MCM 1405 to increase or decrease the flow of fuel to the turbine, thereby increasing or decreasing the rotational speed of turbine 1410. Preferably, control signal 1413 is a pulse width modulated signal having a variable duty cycle. However, other control signals could be used corresponding to the fuel control valve design. For example, a digital signal may be used to increment or decrement a stepper motor within a fuel control valve.

In FIG. 14, generator 1415 is coupled to generator power bus 1440 via auxiliary switch 1423 and in-line fuses 1422. Generator power bus 1440 is monitored by MCM 1405 via sensor circuitry 1441 including, preferably, a current transducer to measure the AC current, and appropriately sized step-down potential transformers coupled to generator power bus 1440. Generator power bus 1440 is coupled to local load 1480 and switchgear 1421 which is connected to utility power bus 1460. In this example, both MCM 1405 and supervisory relay 1420 monitor generator power bus 1440 for faults and for synchronization with utility power bus 1460. MCM 1405 adjusts the flow of fuel to gas turbine 1410 to advance or retard the rotor in generator 1415. MCM 1405 implements a control loop feedback process to synchronize the output voltage waveforms between buses 1440 and 1460. Upon determining that the power output from generator 1415 is synchronized with utility power bus 1460, MCM 1405 will issue a close command. If supervisory relay 1420 also detects that buses 1440 and 1460 are synchronized, supervisory relay 1420 will close allowing the transmission of the close command to switchgear 1421.

MCM 1405 and supervisory relay 1420 will continue to monitor the frequency, phase alignment, and various other parameters, and will trip switchgear 1421 upon the detection of a fault condition. As described in other examples, the generator power output is adjusted in response to the fuel availability. If MCM 1405 detects an insufficient amount of fuel available to maintain a positive torque on generator 1415, MCM 1405 will open auxiliary switch 1423 disengaging generator 1415 from generator power bus 1440 and load 1480. Under normal conditions, load 1480 will continue to be powered by utility power bus 1460 until sufficient fuel is available to re-engage generator 1415 and reinitialize system 1400 by tripping switchgear 1421 and closing auxiliary switch 1423 to reestablish synchronization between power buses 1440 and 1460.

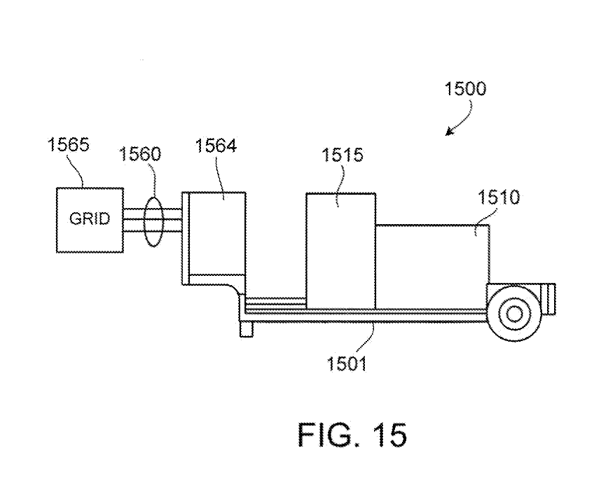

FIG. 15 is an example of a mobile power plant 1500. In FIG. 15, power plant 1500 is arranged on a moveable platform 1501 including, for example, a skid or a trailer. Power plant 1500 optionally includes power transformer(s) 1564 for converting the power output of generator 1515 to match the power requirements on utility power bus 1560. For example, power transformers 1564 may up-convert or down-convert the power output of generator 1515. Such an implementation reduces the burden on the utility company to provide modifications to the infrastructure or utility connection to accommodate power plant 1500. In addition, moveable platform 1501 facilitates the relocation of power plant 1500 from one site to another. Various examples, including those discussed above, can be implemented in the form of a mobile power plant.

In some implementations, the exemplar power generation systems described above also include a diagnostic and/or restart check routine which is performed by MCM 205 prior to reinitiating the operation sequence described in FIG. 4. For instance, if generator 215 stops running, MCM 205 determines the cause of the shutdown and decides whether to initiate startup. Conditions resulting in system failure may include, for example, temperature overheat, low oil or oil pressure, and/or fuel starvation. If the reason for the shutdown is temperature overheat, or low oil or oil pressure, the MCM will delay the startup sequence until an operator clears the condition. If the reason for the shutdown is fuel starvation as sensed by a sensor on engine 210, MCM 205 confirms the condition with information collected from the pressure transducer, checks periodically for restored pressure, and initiates the start sequence depicted in process block 410.

Exemplar power generation systems 1100, 1200, 1300, 1400, and 1500 of FIGS. 11, 12, 13, 14, and 15, respectively, also include communication ports 1126, 1226, 1326, 1426, and 1526, respectively, for transmitting data including, for example, status information and/or alarm notifications to corresponding remote terminals 1190A, 1190B, 1290A, 1290B, 1390A, 1390B, 1490A, 1490B, 1590A, 1590B and for receiving control data from remote terminals. Communication options include, for example, PSTN, DSL, CATV, BPL, and/or wireless services. Preferably, power generation systems 1100, 1200, 1300, 1400, and 1500 are accessible via the internet facilitating web based administration and the use of messaging services such as twitter, e-mail, text-messaging, or other common messaging services. Such messaging services allow the system to communicate status and fault condition information to the operator. For example, emails may be generated automatically to report fault conditions, shutdown conditions and/or operating status. Web-based administration optionally allows an operator to monitor fuel source availability, prime mover performance, generator performance, system capabilities and limitations, and condition abnormalities from remote locations. In addition, communication systems 1125, 1225, 1325, 1425, and 1525 optionally allow a system administrator to manually control and/or reconfigure power generation systems 1100, 1200, 1300, 1400, and 1500 to minimize system down time and anticipate problems through proactive system monitoring. Thus, using the self-monitoring and self-correcting features described above, power generation systems 1100, 1200, 1300, 1400, and 1500 may be left unattended in operation.

In order to maintain a supply of power to the local load, in some examples, the generator includes both a standard generator controller and an MCM. In cases in which the MCM is reprogrammed remotely, in some of these examples the generator can continue to operate using the traditional controller to regulate frequency.

A number of embodiments of the invention have been described. Nevertheless, it will be understood that various modifications may be made without departing from the spirit and scope of the invention. The systems and methods disclosed above may be adapted to other fuel sources and power generation systems. For example, the internal combustion engine and generator can be replaced by a hydroelectric generator with the substitution of a water flow switch for the pressure transducer. Accordingly, other embodiments are within the scope of the following claims.

Additional examples and implementations may include the following features and aspects:

In one aspect, power generation is accomplished by capturing off-gas from a wellhead of an oil producing well, sensing a change in pressure from which a change in available off-gas can be determined, and adjusting a torque supplied by a prime mover to a generator responsive to the change in available off-gas to vary an amount of electricity generated by the generator. In some implementations, off-gas may be accumulated in an accumulator configured to provide a flow of gas to the prime mover. Further, in some cases, generating power may include synchronizing AC voltage waveform characteristics between the electricity generated by the generator and power on a utility grid.

Adjusting the torque supplied by the prime mover may, in some cases, be accomplished by adjusting a flow of gas to the prime mover using a governor. In some cases, adjusting the torque supplied by the prime mover may be accomplished by increasing a flow of gas to the prime mover responsive to an increase in available off-gas and decreasing a flow of gas to the prime mover responsive to a decrease in available off-gas. Further, adjusting the torque supplied by the prime mover may in some cases include increasing a duty cycle of a pulse width modulated control signal provided to a speed governor of the prime mover in response to an increase in the pressure sensed. Still further, in some implementations, adjusting the torque supplied by the prime mover may be accomplished by decreasing a duty cycle of a pulse width modulated control signal provided to a speed governor of the prime mover in response to a decrease in the pressure serised.

In another aspect, a power generation control system includes control circuitry configured to receive a signal from which a change in a flow rate of gas captured from a wellhead can be determined, and to vary a flow rate of gas supplied to a prime mover responsive to the received signal. In some implementations, the power generation control system also includes a phase comparator configured to detect phase alignment between two A.C. voltage waveforms, and a pulse width modulated signal generator configured to adjust a duty cycle of a pulse width modulated signal in response to the detected phase alignment. Some examples of the power generation system may include synchronization logic coupled with the control circuitry, phase comparator, and pulse width modulated signal generator. In such cases, the synchronization logic is adapted to provide a control signal to the pulse width modulated signal generator to increase the duty cycle of the pulse width modulated signal in response to the phase comparator detecting a phase of a first A.C. voltage waveform is leading with respect to a phase of a second A.C. voltage waveform, and to decrease the duty cycle of the pulse width modulated signal in response to the phase comparator detecting the phase of the first A.C. voltage waveform is lagging with respect to the phase of the second A.C. voltage waveform.

In some implementations, the power generation control system also includes sensor circuitry coupled to the control circuitry. In such cases, the sensor circuitry is adapted to generate output signals responsive to measured A.C. voltage waveform characteristics. In some examples, the sensor circuitry is adapted to provide phase angle, frequency, and voltage information to the control circuitry. In some examples, the sensor circuitry is adapted to generate the signal from which the change in the flow rate of gas captured from the wellhead can be determined. The sensor circuitry may be, for example, a pressure transducer.

In still another aspect, power is supplied to a utility grid by capturing gas from a wellhead, providing gas to a prime mover coupled with a generator, synchronizing power generated by the generator to the utility grid, coupling the generator to the utility grid, detecting a change in flow rate of gas captured from the wellhead, and adjusting a flow rate of gas provided to the prime mover in response to the change in flow rate of gas captured from the wellhead. In some implementations, the flow rate of gas provided to the prime mover is controlled to approximate the flow rate of gas captured from the wellhead.

In a further aspect, a power generation system includes a control module coupled to a generator and configured to increase an amount of power generated in response to an increase in an amount of fuel available from a fuel source, and to decrease the amount of power generated in response to a decrease in the amount of fuel available from the fuel source. The generator is configured to supply power to meet at least a portion of a demand from a local load, and to supply power to a utility grid when the amount of power generated exceeds the demand from the local load. In some examples, the fuel source is an oil well and/or a natural gas well.

In some implementations, the power generation system includes fault sensing circuitry coupled to the generator and to the control module and adapted to detect a fault condition, and a switchgear coupling the generator to the utility grid, the control module adapted to trip the switchgear in response to the fault sensing circuitry detecting the fault condition.

What is claimed is:

1. A method of generating electricity comprising:
capturing off-gas from a wellhead of an oil producing well;
sensing a change in pressure from which a change in available off-gas can be determined; and
adjusting a torque supplied by a prime mover to a generator responsive to the change in available off-gas to vary an amount of electricity generated by the generator.

2. The method of claim 1 further comprising accumulating the off-gas in an accumulator configured to provide a flow of gas to the prime mover.

3. The method of claim 1 further comprising:
synchronizing AC voltage waveform characteristics between the electricity generated by the generator and power on a utility grid.

4. The method of claim 1 wherein adjusting the torque supplied by the prime mover includes adjusting a flow of gas to the prime mover using a governor.

5. The method of claim 1 wherein adjusting the torque supplied by the prime mover includes increasing a flow of gas to the prime mover responsive to an increase in available off-gas and decreasing a flow of gas to the prime mover responsive to a decrease in available off-gas.

6. The method of claim 1 wherein adjusting the torque supplied by the prime mover includes increasing a duty cycle of a pulse width modulated control signal provided to a speed governor of the prime mover in response to an increase in the pressure sensed.

7. The method of claim 1 wherein adjusting the torque supplied by the prime mover includes decreasing a duty cycle of a pulse width modulated control signal provided to a speed governor of the prime mover in response to a decrease in the pressure sensed.

8. A power generation control system comprising:
control circuitry configured to receive a signal from which a change in a flow rate of gas captured from a wellhead can be determined, and to vary a flow rate of gas supplied to a prime mover responsive to the received signal.

9. The power generation control system of claim 8 further comprising:
a phase comparator configured to detect phase alignment between two A.C. voltage waveforms; and
a pulse width modulated signal generator configured to adjust a duty cycle of a pulse width modulated signal in response to the detected phase alignment.

10. The power generation control system of claim 9 further comprising:
synchronization logic coupled with the control circuitry, phase comparator, and pulse width modulated signal generator,
the synchronization logic adapted to provide a control signal to the pulse width modulated signal generator to
increase the duty cycle of the pulse width modulated signal in response to the phase comparator detecting a phase of a first A.C. voltage waveform is leading with respect to a phase of a second A.C. voltage waveform, and to
decrease the duty cycle of the pulse width modulated signal in response to the phase comparator detecting the phase of the first A.C. voltage waveform is lagging with respect to the phase of the second A.C. voltage waveform.

11. The power generation control system of claim 8 further comprising:
sensor circuitry coupled to the control circuitry and adapted to generate output signals responsive to measured A.C. voltage waveform characteristics.

12. The power generation control system of claim 11 wherein the sensor circuitry is adapted to provide phase angle, frequency, and voltage information to the control circuitry.

13. The power generation control system of claim 8 further comprising:
sensor circuitry coupled to the control circuitry and adapted to generate the signal from which the change in the flow rate of gas captured from the wellhead can be determined.

14. The power generation control system of claim 13 wherein the sensor circuitry includes a pressure transducer.

15. A method of supplying power to a utility grid comprising:
capturing gas from a wellhead;
is providing gas to a prime mover coupled with a generator;
synchronizing power generated by the generator to the utility grid;
coupling the generator to the utility grid;
detecting a change in flow rate of gas captured from the wellhead; and
adjusting a flow rate of gas provided to the prime mover in response to the change in flow rate of gas captured from the wellhead.

16. The method of claim 15 wherein the flow rate of gas provided to the prime mover is controlled to approximate the flow rate of gas captured from the wellhead.

17. A power generation system comprising:
a control module coupled to a generator and configured to increase an amount of power generated in response to an increase in an amount of fuel available from a fuel source, and to decrease the amount of power generated in response to a decrease in the amount of fuel available from the fuel source,
the generator configured to supply power to meet at least a portion of a demand from a local load, and to supply power to a utility grid when the amount of power generated exceeds the demand from the local load.

18. The power generation system of claim 17 wherein the fuel source is an oil well.

19. The power generation system of claim 17 wherein the fuel source is a natural gas well.

20. The power generation system of claim 17 further comprising:
fault sensing circuitry coupled to the generator and to the control module and adapted to detect a fault condition; and
a switchgear coupling the generator to the utility grid, the control module adapted to trip the switchgear in response to the fault sensing circuitry detecting the fault condition.
